(19) United States
(12) Patent Application Publication
(10) Pub. No.: US 2012/0263184 A1
(43) Pub. Date: Oct. 18, 2012

(54) BASEBAND ETHERNET EXTENDER

(76) Inventor: CHIEN-CHUNG LEE, New Taipei City (TW)

(21) Appl. No.: 13/084,573

(22) Filed: Apr. 12, 2011

(51) Int. Cl. H04L 12/56

(52) U.S. Cl. 370/400

(57) ABSTRACT

A baseband Ethernet extender includes a first transmission device and a second transmission device. The first transmission device and the second transmission devices form therein at least one first baseband Ethernet connection unit and at least one second baseband Ethernet connection unit, respectively. The second baseband Ethernet connection unit is electrically connected through at least one twisted pair cable assembly to the first baseband Ethernet connection unit. Each twisted pair cable constituting the twisted pair cable assembly is electrically connected, at least at one end thereof, to a baseband signal compensation unit. Such an arrangement allows an Ethernet baseband signal to be transmitted to a distance exceeding 100 meters.

### TECHNICAL FIELD OF THE INVENTION

The present invention generally relates to an Ethernet extender, and more particularly to an Ethernet extender that extends transmission distance of Ethernet baseband signals beyond 100 meter by adopting twisted pair cable(s) as a transmission medium.

### DESCRIPTION OF THE PRIOR ART

Due to the geometric growth of networked computer connection and reliable and worldwide popularization of transmission media, new technologies have been developed to push the information era to a complete and mature condition. Nowadays, household and commercial consumers are getting accustomed to diversified ways of communication. Specifically, multimedia applications (which may include texts, figures, images, and video, audio, and sound information) are now commonly used. Local area networks (LANs) are becoming an essential part of working power of digital workshops. Ethernets takes the first place in the LAN market and is increasingly expanding. For example, switched Ethernet, fast Ethernet, and Gigabit Ethernet are new evolving with wideband multimedia applications.

Taking a baseband Ethernet as an example, a regular Ethernet baseband signal is limited in its transmission distance to be less than 100 meters. To make a transmission beyond 100 meters, additional facilities must be provided to expand the transmission distance. This increases installation cost and does not suit the needs for the current trends.

### SUMMARY OF THE INVENTION

An objective of the present invention is to provide a baseband Ethernet extender, which comprises a first transmission device. The first transmission device forms at least one first baseband Ethernet connection unit. The first baseband Ethernet connection unit is electrically connected through at least one twisted pair cable assembly to a second baseband Ethernet connection unit contained in a second transmission device. The twisted pair cable assembly comprises a first twisted pair cable and a second twisted pair cable. Each of the twisted pair cables is electrically connected, at least at one end thereof, to a baseband signal compensation unit. The baseband signal compensation unit is electrically connected, at one side thereof away from the twisted pair cable, to a differential baseband Ethernet input/output port. The baseband signal compensation unit functions to perform signal amplitude compensation, signal spectrum compensation, or signal amplitude and spectrum compensation. As such, in transmitting a baseband signal, the Ethernet baseband signal is input through the differential baseband Ethernet input/output port and then the Ethernet baseband signal is transmitted by the first transmission device through the twisted pair cable to the second transmission device in such a way that compensation of the signal is performed by the baseband signal compensation unit to allow the Ethernet baseband signal to be transmitted to a distance exceeding 100 meters. With such a technology, an effective solution for transmission of Ethernet baseband signal over 100 meters is provided to solve the problems that the conventional baseband Ethernet is only capable of transmitting an Ethernet baseband signal within a range less than 100 meters and that additional facility must be installed for extension of the transmission distance to exceed 100 meters, this being expensive and not meeting the needs of the current trends.

Another objective of the present invention is that the baseband signal compensation unit is provided with a transmission/reception separation unit, which functions to separate received and transmitted baseband network signals, or a transmission/reception integration unit, which functions to integrate received and transmitted baseband network signals.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a preferred embodiment according to the present invention.

FIG. 2 is a block diagram of a first embodiment according to the present invention.

FIG. 3 is a block diagram of a second embodiment according to the present invention.

FIG. 4 is a block diagram of a third embodiment according to the present invention.

FIG. 5 is a block diagram of a fourth embodiment according to the present invention.

FIG. 6 is a block diagram of a fifth embodiment according to the present invention.

FIG. 7 is a block diagram of a sixth embodiment according to the present invention.

FIG. 8 is a block diagram of a seventh embodiment according to the present invention.

FIG. 9 is a block diagram of an eighth embodiment according to the present invention.

FIG. 10 is a block diagram of a ninth embodiment according to the present invention.

FIG. 11 is a block diagram of a tenth embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

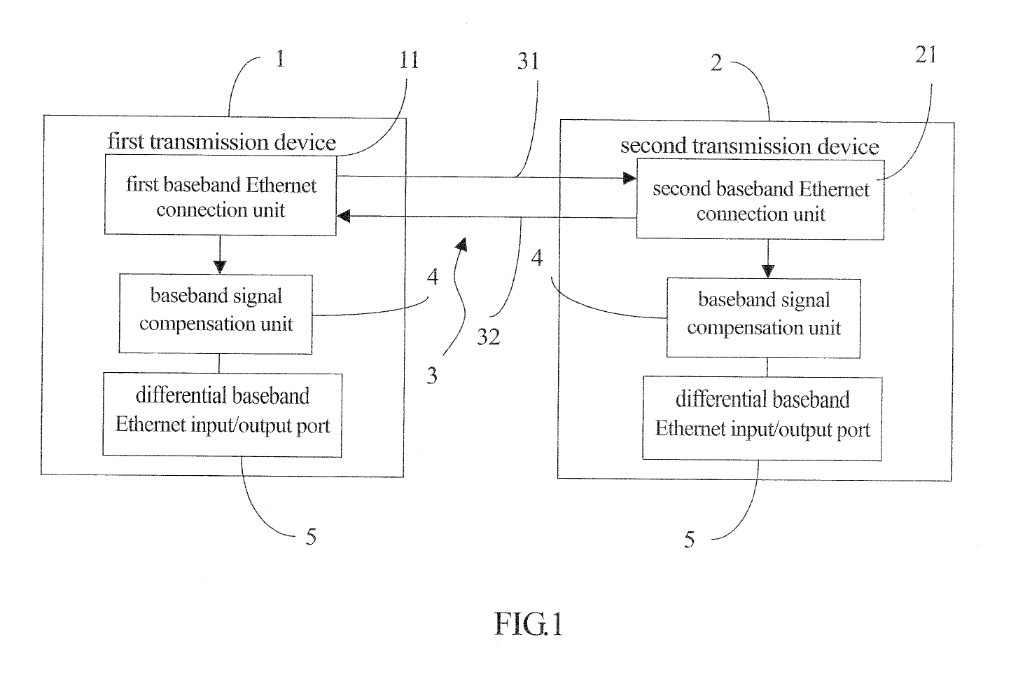

Referring to FIG. 1, which is a block diagram of a preferred embodiment according to the present invention, the present invention provides a baseband Ethernet extender, which comprises the following constituent components:

A first transmission device 1 forms therein at least one first baseband Ethernet connection unit 11. The first baseband Ethernet connection unit 11 is preferably a Power-over-Ethernet (POE) interface.

A second transmission device 2 forms therein at least one second baseband Ethernet connection unit 21. The second baseband Ethernet connection unit 21 is preferably a POE interface. The second baseband Ethernet connection unit 21 is electrically connected to the first baseband Ethernet connection unit 11 through at least one twisted pair cable assembly 3, which is capable of transmitting electrical power at the same time of transmitting signal (the twisted pair cable assembly 3 referred hereinafter being capable of transmitting electrical power and at the same time serving as a LAN (Local Area Network) Cable). The twisted pair cable assembly 3 is composed of a first twisted pair cable 31 and a second twisted pair cable 32. Each of the twisted pair cables is electrically connected, at least at one end thereof, to a baseband signal compensation unit 4, and the baseband signal compensation unit 4 is electrically connected, at one side thereof away from the end of the twisted pair cable, to a differential baseband Ethernet input/output port 5. The baseband signal compensation unit 4 performs signal amplitude compensation, signal spectrum compensation, or signal amplitude and spectrum compensation.

Further, the second transmission device 2 may be a regular network device.

Taking FIG. 1 as an example for illustration, the first twisted pair cable 31 is electrically connected, at the end thereof at the second baseband Ethernet connection unit 21 side, to a baseband signal compensation unit 4. The second twisted pair cable 32 is electrically connected, at the end thereof at the first baseband Ethernet connection unit 11 side, to a baseband signal compensation unit 4.

As such, when the first transmission device 1 transmits an Ethernet baseband signal through a twisted pair cable to the second transmission device 2, the baseband signal compensation unit 4 performs compensation, and then signal output is made with the differential baseband Ethernet input/output port 5. On the other hand, when the second transmission device 2 transmits an Ethernet baseband signal through a twisted pair cable to the first transmission device 1, the baseband signal compensation unit 4 performs compensation, and then output is made with the differential baseband Ethernet input/output port 5.

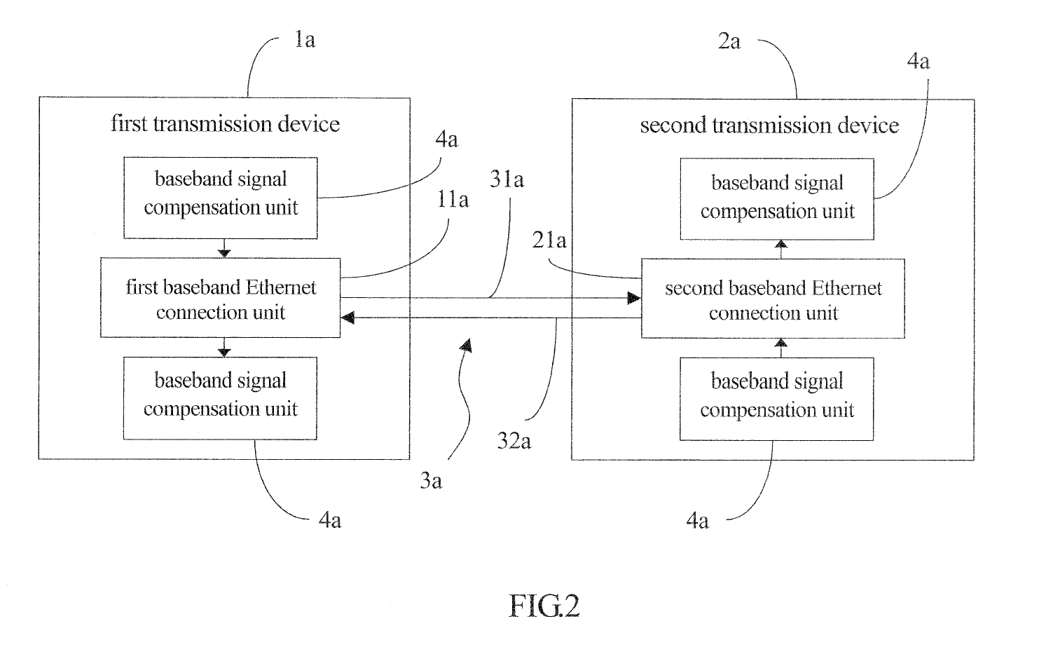

Referring to FIG. 2, which is a block diagram of a first embodiment according to the present invention, as shown, the first embodiment comprises a first transmission device 1a and a second transmission device 2a. The first transmission device 1a forms at least one first baseband Ethernet connection unit 11a, and the second transmission device 2a forms at least one second baseband Ethernet connection unit 21a. The second baseband Ethernet connection unit 21a is electrically connected through at least one twisted pair cable assembly 3a to the first baseband Ethernet connection unit 11a. The first twisted pair cable 31a is electrically connected, at each end thereof at the first baseband Ethernet connection unit 11a side and the second baseband Ethernet connection unit 21a side, to a baseband signal compensation unit 4a. The second twisted pair cable 32a is electrically connected, at each end thereof at the first baseband Ethernet connection unit 11a side and the second baseband Ethernet connection unit 21a side, to a baseband signal compensation unit 4a.

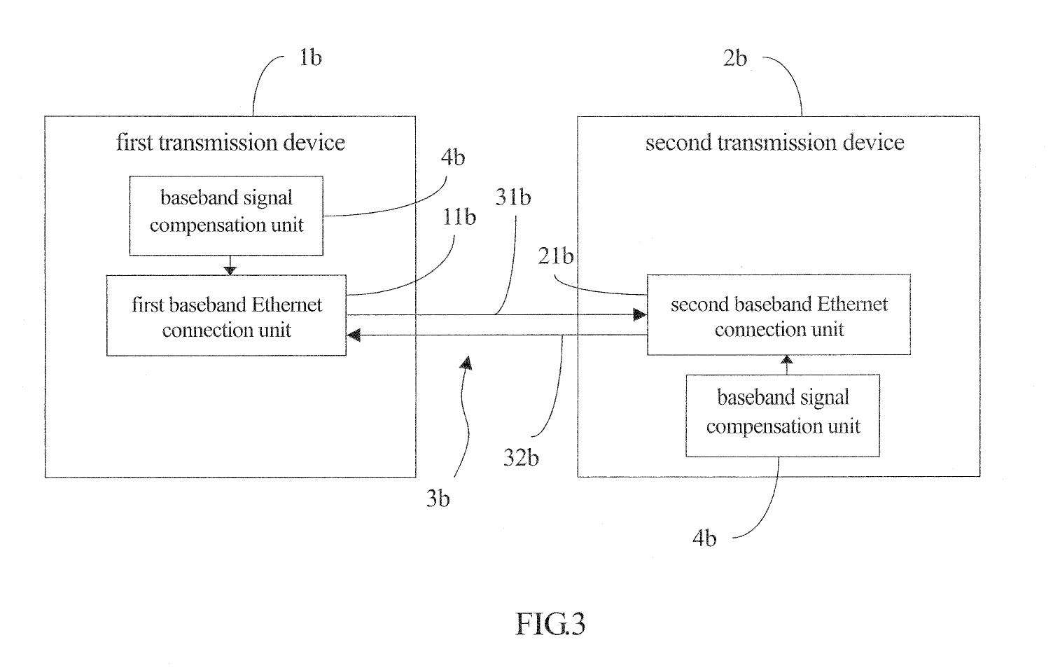

Referring to FIG. 3, which is a block diagram of a second embodiment according to the present invention, as shown, the second embodiment comprises a first transmission device 1b and a second transmission device 2b. The first transmission device 1b forms at least one first baseband Ethernet connection unit 11b, and the second transmission device 2b forms at least one second baseband Ethernet connection unit 21b. The second baseband Ethernet connection unit 21b is electrically connected through at least one twisted pair cable assembly 3b to the first baseband Ethernet connection unit 11b. The first twisted pair cable 31b is electrically connected, at one end thereof at the first baseband Ethernet connection unit 11b side, to a baseband signal compensation unit 4b. The second twisted pair cable 32b is electrically connected, at one end thereof at the second baseband Ethernet connection unit 21b side, to a baseband signal compensation unit 4b.

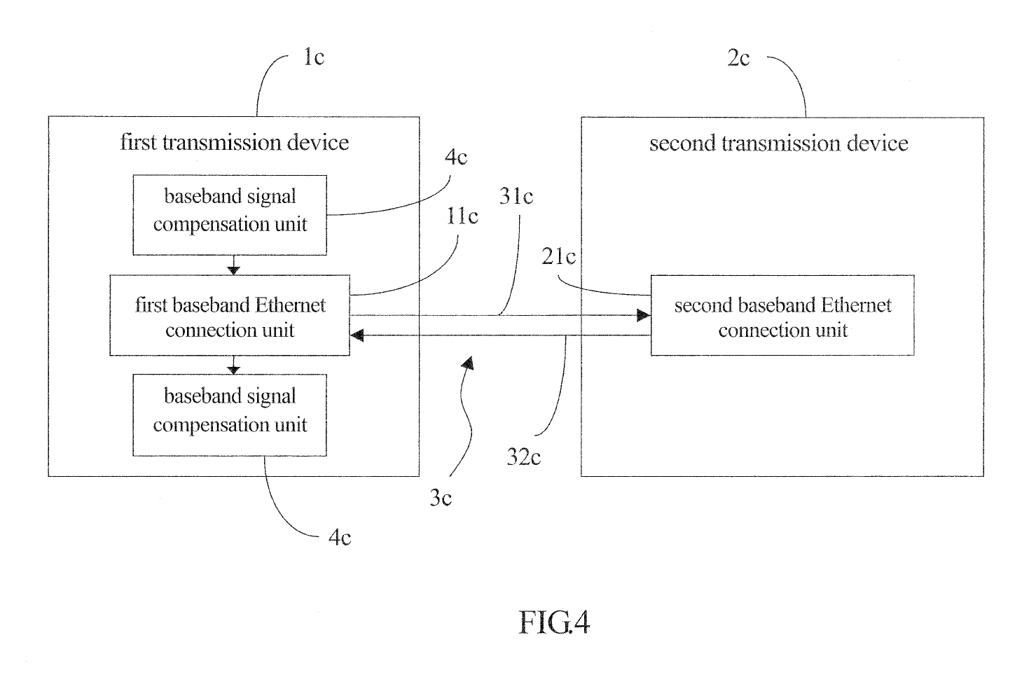

Referring to FIG. 4, which is a block diagram of a third embodiment according to the present invention, as shown, the third embodiment comprises a first transmission device 1c and a second transmission device 2c. The first transmission device 1c forms at least one first baseband Ethernet connection unit 11c, and the second transmission device 2c forms at least one second baseband Ethernet connection unit 21c. The second baseband Ethernet connection unit 21c is electrically connected through at least one twisted pair cable assembly 3c, which in the embodiment illustrated includes a first twisted pair cable 31c and a second twisted pair cable 32c, to the first baseband Ethernet connection unit 11c. The first twisted pair cable 31c is electrically connected, at one end thereof at the first baseband Ethernet connection unit 11c side, to a baseband signal compensation unit 4c. The second twisted pair cable 32c is electrically connected, at one end thereof at the first baseband Ethernet connection unit 11c side, to a baseband signal compensation unit 4c.

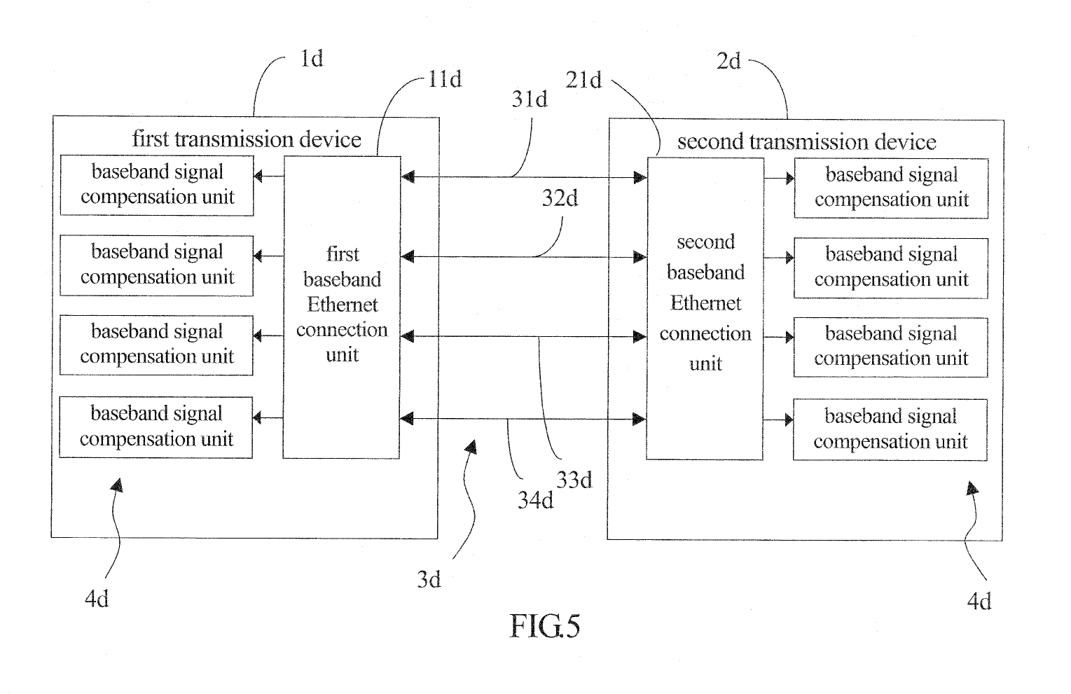

Referring to FIG. 5, which is a block diagram of a fourth embodiment according to the present invention, as shown, the fourth embodiment comprises a first transmission device 1d and a second transmission device 2d. The first transmission device 1d forms at least one first baseband Ethernet connection unit 11d, and the second transmission device 2d forms at least one second baseband Ethernet connection unit 21d. The second baseband Ethernet connection unit 21d is electrically connected through at least one twisted pair cable assembly 3d to the first baseband Ethernet connection unit 11d. The twisted pair cable assembly 3d includes a first twisted pair cable 31d, a second twisted pair cable 32d, a third twisted pair cable 33d, and a fourth twisted pair cable 34d. Each of these twisted pair cables is electrically connected, at each of two ends thereof, to a baseband signal compensation unit 4d. The baseband signal compensation unit 4d may perform signal amplitude compensation, signal spectrum compensation, or signal amplitude and spectrum compensation. The first twisted pair cable 31d, the second twisted pair cable 32d, the third twisted pair cable 33d, and the fourth twisted pair cable 34d may allow for bi-directional communication. Further, the Ethernet extender is an Ethernet extender for transmission speed of 1 Giga Ethernet or exceeding 1 Giga Ethernet.

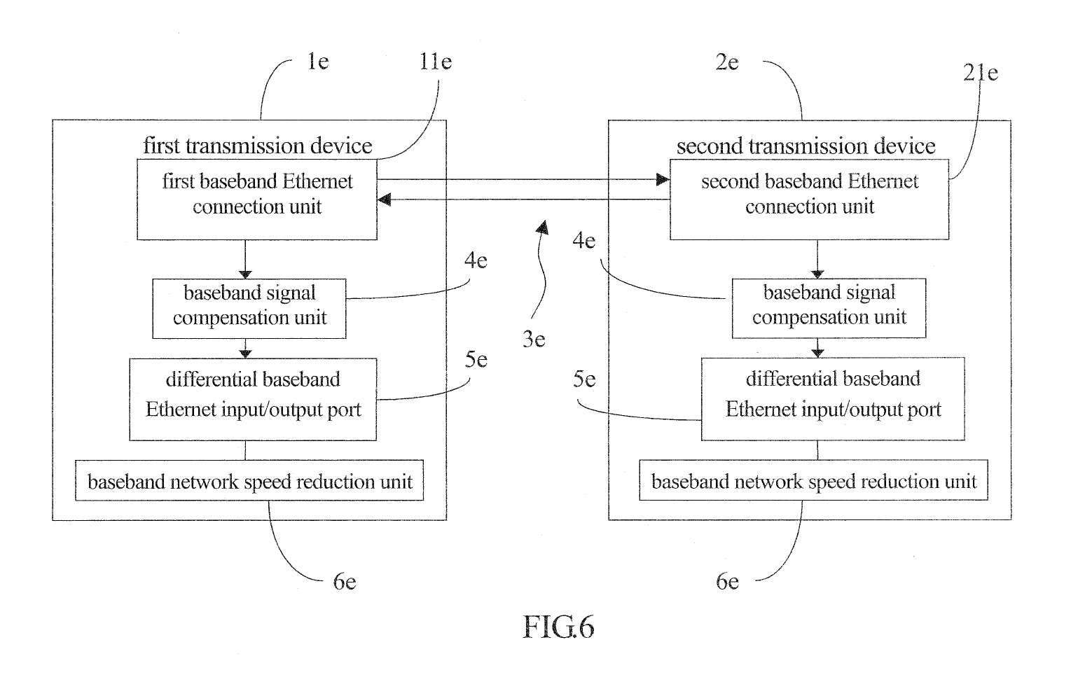

Referring to FIG. 6, which is a block diagram of a fifth embodiment according to the present invention, as shown, the fifth embodiment comprises a first transmission device 1e and a second transmission device 2e. The first transmission device 1e forms at least one first baseband Ethernet connection unit 11e, and the second transmission device 2e forms at least one second baseband Ethernet connection unit 21e. The second baseband Ethernet connection unit 21e is electrically connected through at least one twisted pair cable assembly 3e to the first baseband Ethernet connection unit 11e, and the baseband signal compensation unit 4e is electrically connected, at one side away from the end of the twisted pair cable, to a differential baseband Ethernet input/output port 5e. The differential baseband Ethernet input/output port 5e is further electrically connected to at least one baseband network speed reduction unit 6e.

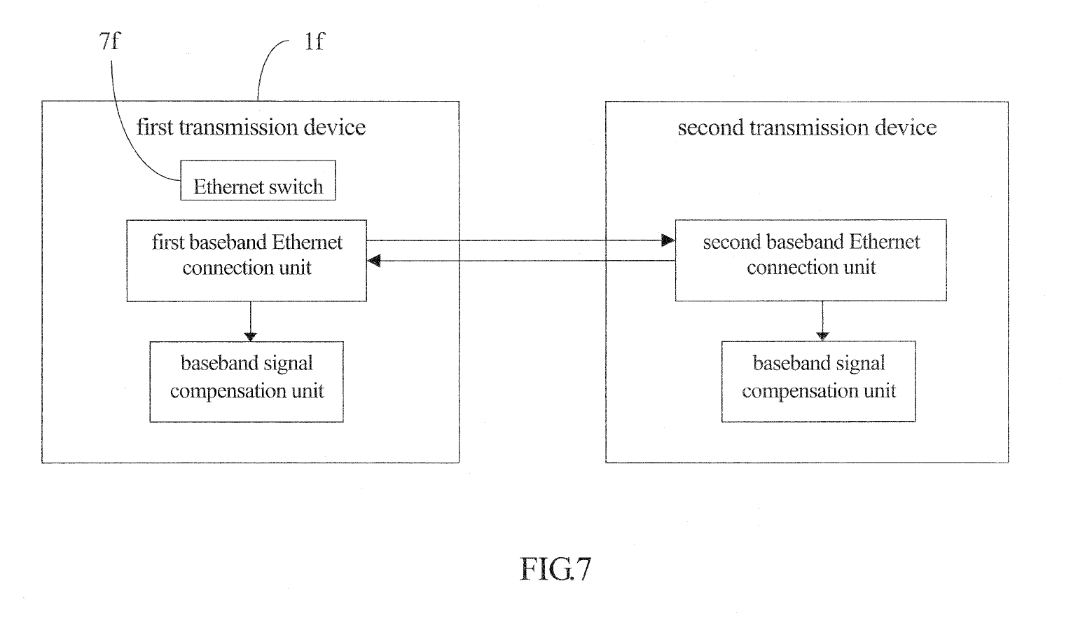

Referring to FIG. 7, which is a block diagram of a sixth embodiment according to the present invention, as shown, the first transmission device 1f further comprises a switch IC module, so that an Ethernet switch 7f having the function of extender is formed.

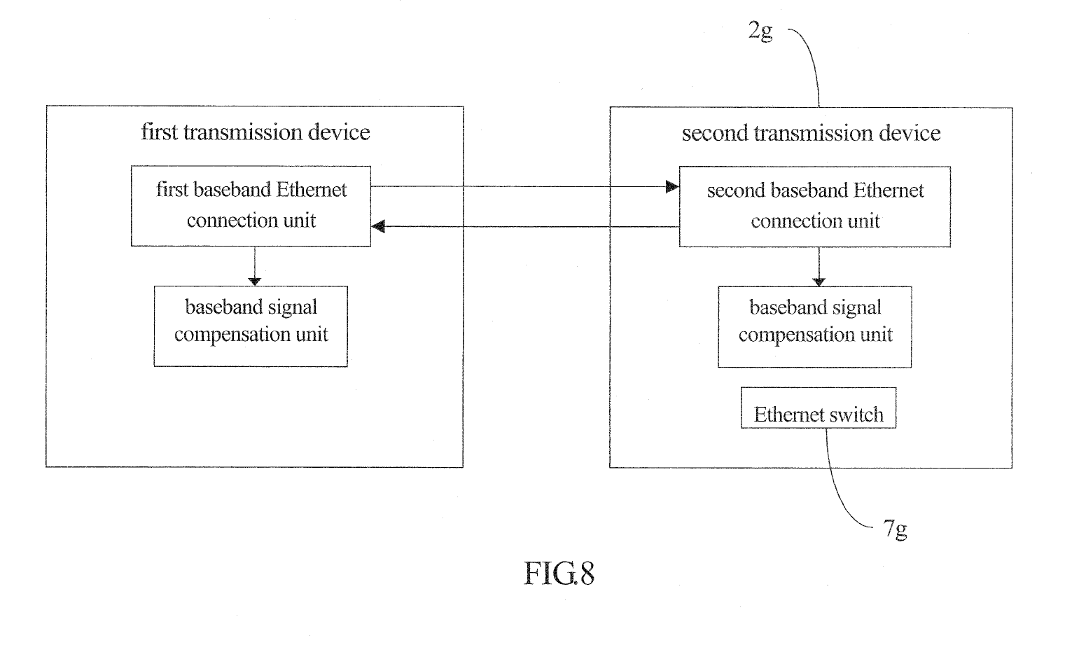

Referring to FIG. 8, which is a block diagram of a seventh embodiment according to the present invention, as shown, the second transmission device 2g further comprises a switch IC module, so that an Ethernet switch 7g having the function of extender is formed.

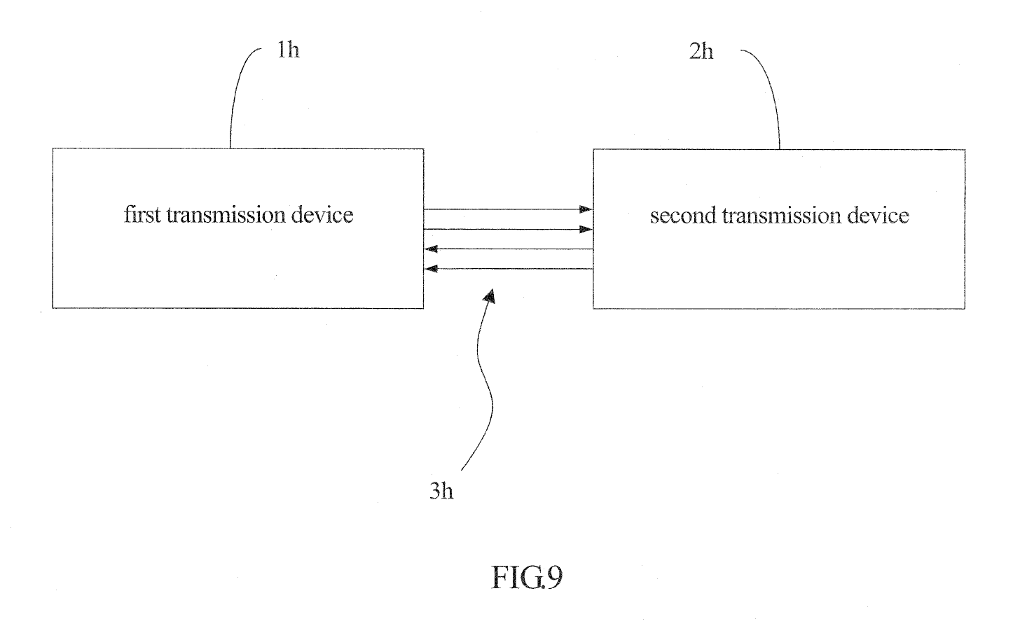

Referring to FIG. 9, which is a block diagram of an eighth embodiment according to the present invention, as shown, the twisted pair cable assembly 3h is split into two sub-assemblies, each being of unidirectional communication. One sub-assembly functions to transmit a baseband network signal from the first transmission device 1h to the second transmission device 2h, while the other sub-assembly functions to transmit a baseband network signal from the second transmission device 2h to the first transmission device 1h.

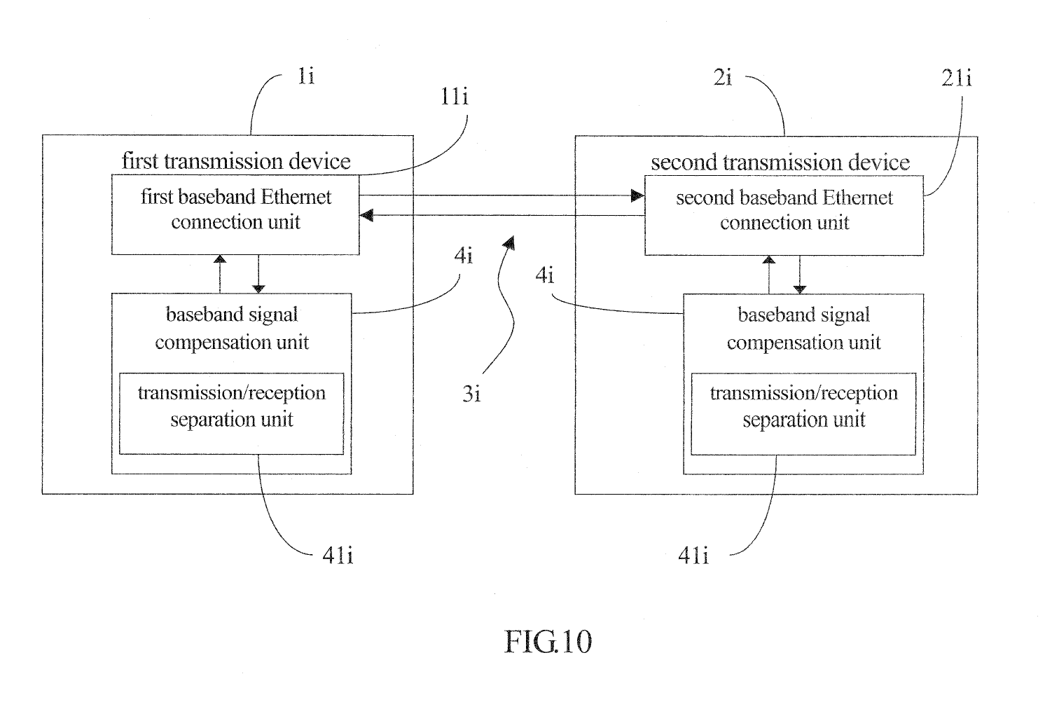

Referring to FIG. 10, which is a block diagram of a ninth embodiment according to the present invention, as shown, the ninth embodiment comprises a first transmission device 1i and a second transmission device 2i. The first transmission device 1i forms at least one first baseband Ethernet connection unit 11i, and the second transmission device 2i forms at least one second baseband Ethernet connection unit 21i. The second baseband Ethernet connection unit 21i is electrically connected through at least one twisted pair cable assembly 3i to the first baseband Ethernet connection unit 11i. The baseband signal compensation unit 4i further comprises a transmission/reception separation unit 41i, which functions to separate received and transmitted baseband network signals.

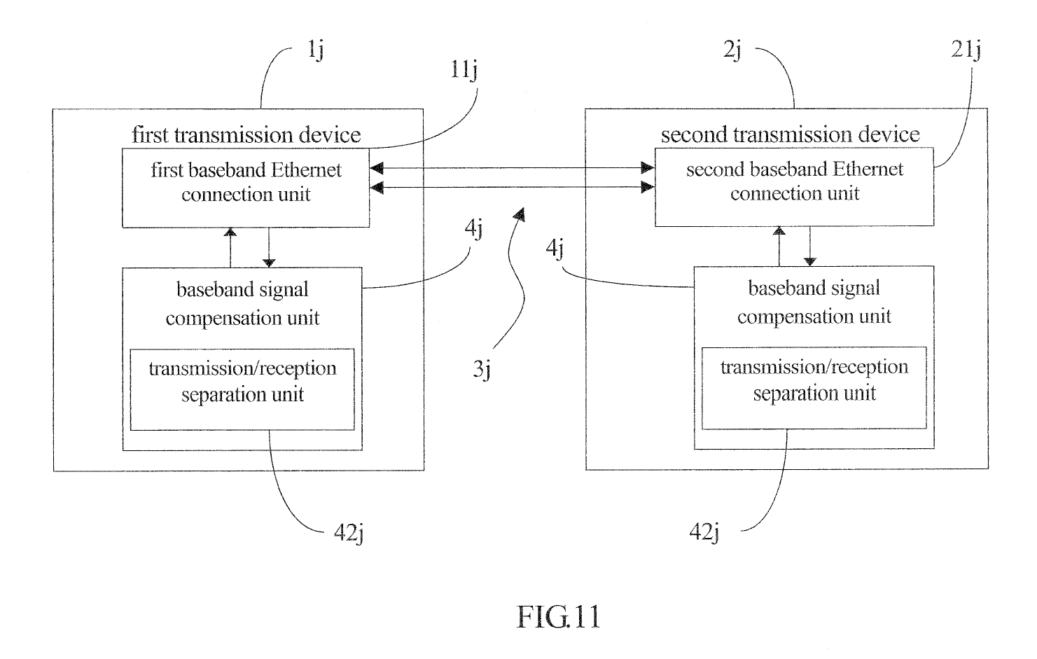

Referring to FIG. 11, which is a block diagram of a tenth embodiment according to the present invention, as shown, the tenth embodiment comprises a first transmission device 1j and a second transmission device 2j. The first transmission device 1j forms at least one first baseband Ethernet connection unit 11j, and the second transmission device 2j forms at least one second baseband Ethernet connection unit 21j. The second baseband Ethernet connection unit 21j is electrically connected through at least one twisted pair cable assembly 3j to the first baseband Ethernet connection unit 11j. The baseband signal compensation unit 4j further comprises a transmission/reception integration unit 42j, which functions to integrate received and transmitted baseband network signals.

Thus, as shown in the drawings, the present invention provides the following advantage:

The present invention allows an Ethernet baseband signal to be transmitted through a transmission medium formed of twisted pair cables to a distance exceeding 100 meters and is applicable to transmission in any transmission direction.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A baseband Ethernet extender, comprising:
a first transmission device, which forms at least one first baseband Ethernet connection unit; and
a second transmission device, which forms at least one second baseband Ethernet connection unit, the second baseband Ethernet connection unit being electrically connected through at least one twisted pair cable assembly to the first baseband Ethernet connection unit, the twisted pair cable assembly comprising a first twisted pair cable and a second twisted pair cable, each of which is electrically connected, at least at one end thereof to a baseband signal compensation unit, the baseband signal compensation unit being electrically connected, at one side thereof away from the twisted pair cable, to a differential baseband Ethernet input/output port, the baseband signal compensation unit performing signal amplitude compensation, signal spectrum compensation, or signal amplitude and spectrum compensation.

2. The baseband Ethernet extender according to claim 1, wherein the first twisted pair cable is electrically connected, at an end thereof at the second baseband Ethernet connection unit side, to a baseband signal compensation unit, and the second twisted pair cable is electrically connected, at an end thereof at the first baseband Ethernet connection unit side, to a baseband signal compensation unit.

3. The baseband Ethernet extender according to claim 1, wherein the first twisted pair cable is electrically connected, at each of ends thereof at the first baseband Ethernet connection unit side and the second baseband Ethernet connection unit side, to a baseband signal compensation unit, and the second twisted pair cable is electrically connected, at each of ends thereof at the first baseband Ethernet connection unit side and the second baseband Ethernet connection unit side, to a baseband signal compensation unit

4. The baseband Ethernet extender according to claim 1, wherein the first twisted pair cable is electrically connected, at an end thereof at the first baseband Ethernet connection unit side, to a baseband signal compensation unit, and the second twisted pair cable is electrically connected, at an end thereof at the second baseband Ethernet connection unit side, to a baseband signal compensation unit.

5. The baseband Ethernet extender according to claim I , wherein the first twisted pair cable is electrically connected, at an end thereof at the first baseband Ethernet connection unit side, to a baseband signal compensation unit, and the second twisted pair cable is electrically connected, at an end thereof at the first baseband Ethernet connection unit side, to a baseband signal compensation unit.

6. The baseband Ethernet extender according to claim 1, wherein the second baseband Ethernet connection unit is electrically connected through a twisted pair cable assembly to the first baseband Ethernet connection unit, the twisted pair cable assembly comprising a first twisted pair cable, a second twisted pair cable, a third twisted pair cable, a fourth twisted pair cable, each of the twisted pair cables being electrically connected, at each of two ends thereof, to a baseband signal compensation unit, the baseband signal compensation unit performing signal amplitude compensation, signal spectrum compensation, or signal amplitude and spectrum compensation.

7. The baseband Ethernet extender according to claim 6, wherein the first twisted pair cable, the second twisted pair cable, the third twisted pair cable, and the fourth twisted pair cable allow for bi-directional communication.

8. The baseband Ethernet extender according to claim 1, wherein the twisted pair cable assembly allows for transmission of electrical power.

9. The baseband Ethernet extender according to claim 1, wherein the first baseband Ethernet connection unit comprises a POE interface.

10. The baseband Ethernet extender according to claim 1, wherein the second baseband Ethernet connection unit comprises a POE interface.

11. The baseband Ethernet extender according to claim 1, wherein the twisted pair cables are LAN cables.

12. The baseband Ethernet extender according to claim 6, wherein the twisted pair cables are LAN cables.

13. The baseband Ethernet extender according to claim 1, wherein the second transmission device comprises a regular network device.

14. The baseband Ethernet extender according to claim 6, wherein the Ethernet extender is an Ethernet extender for transmission speed of 1 Giga Ethernet or exceeding 1 Giga Ethernet.

15. The baseband Ethernet extender according to claim 1, wherein the differential baseband Ethernet input/output port is further electrically connected to at least one baseband network speed reduction unit.

16. The baseband Ethernet extender according to claim 6, wherein the differential baseband Ethernet input/output port is further electrically connected to at least one baseband network speed reduction unit.

17. The baseband Ethernet extender according to claim 1, wherein the first transmission device comprises a switch IC module so as to form an Ethernet switch having the function of extender.

18. The baseband Ethernet extender according to claim 1, wherein the second transmission device comprises a switch IC module, so as to form an Ethernet switch having the function of extender.

19. The baseband Ethernet extender according to claim 1, wherein the twisted pair cable assembly comprises two sub-assemblies, each being of unidirectional communication, one of the sub-assemblies transmitting a baseband network signal from the first transmission device to the second transmission device, the other one of the sub-assemblies transmitting a baseband network signal from the second transmission device to the first transmission device.

20. The baseband Ethernet extender according to claim 1, wherein the baseband signal compensation unit comprises a transmission/reception separation unit that separates received and transmitted baseband network signals.

21. The baseband Ethernet extender according to claim 18, wherein the baseband signal compensation unit comprises a transmission/reception integration unit that integrates received and transmitted baseband network signals.
